(19) United States
(12) Patent Application Publication
(10) Pub. No.: US 2010/0228167 A1
(43) Pub. Date: Sep. 9, 2010

(54) Implantable Magnetically Activated Actuator

(76) Inventors: Mordechay Ilovich, Haifa (IL); Elik Chen, Naharia (IL)

Correspondence Address: NIXON & VANDERHYE, PC, 901 NORTH GLEBE ROAD, 11TH FLOOR, ARLINGTON, VA, 22203, US

(21) Appl. No.: 11/989,795

(22) PCT Filed: Jul. 31, 2006
(86) PCT No.: PCT/IL2006/000888

§ 371 Date: May 7, 2010

Related U.S. Application Data
(60) Provisional application No. 60/703,884, filed on Aug. 1, 2005.

(30) Foreign Application Priority Data
Feb. 22, 2006 (US) 2006/000240

(51) Int. Cl. A61H 7/00

(52) U.S. Cl. 601/89

(57) ABSTRACT

An implantable magnetically activated actuator suitable for causing distraction, compression/contraction and/or oscillation of body organs and/or bones, comprising: a hollow housing comprising rear and front ends; a rod movably disposed in the rear portion of said hollow housing; magnetic coupling means comprising static magnetic/ferromagnetic elements affixed along the inner wall of said hollow housing and movable magnetic/ferromagnetic elements affixed along said movable rod in proximity to said stationary magnetic/ferromagnetic elements; mechanical means for transferring reciprocating motion of said movable rod.

### FIELD OF THE INVENTION

The present invention relates to magnetically actuated implantable devices used for in-vivo manipulating body organs. More particularly, the present invention relates to an implantable magnetically activated actuator suitable for distracting, contracting, or oscillating body organs, such as soft tissues and bones, as used in intramedullary applications and in the treatment of various skeletal deformities.

### BACKGROUND OF THE INVENTION

The present invention aims to provide an implantable actuator that is activated by an externally induced magnetic field. There were various prior art publications which described implantable devices that can be used to mechanically manipulate body organs or bones by means of an externally applied magnetic force. However, the prior art devices fails to proved sufficient solutions to a major difficulty of such devices, that is to efficiently convert the externally applied magnetic forces into mechanical motions.

WO 99/51160 (by Harris Ivor Rex et al.) Describes a distraction device utilizing a magnetic element mounted on one part of the device which becomes movable under an externally applied magnetic field.

U.S. Pat. No. 3,976,060 describes an extension apparatus comprising a tongue made of magnetic material, or having magnets attached to it, wherein an externally applied magnetic field causes movements of the tongue which are used to rotate a spindle by means of a transmission linkage.

U.S. Pat. No. 5,704,939 (by Justin Daniel F.) describes an intrameduallary distractor for effecting progressive elongation of a sectioned bone which is activated by an external magnetic field. The activation method in this device is based on an extracutaneous circumferentially directed magnetic signal that causes rotations of an elongated rod comprising a responsive magnetic material.

The methods described above have not yet provided satisfactory solutions to the problems of the prior art. Therefore there is a need for an implantable magnetically activated actuator that overcomes the above mentioned problems.

It is therefore an object of the present invention to provide an implantable actuator, for manipulating body bones or organs, that can be efficiently activated by an external magnetic field.

It is another object of the present invention to provide an implantable mechanism that is capable of efficiently transforming an applied magnetic field into axial or rotary mechanical motions.

It is a further object of the present invention to provide an implantable mechanism that in serial and/or parallel operation can efficiently convert axial movements into rotary motions.

Other objects and advantages of the invention will become apparent as the description proceeds.

### SUMMARY OF THE INVENTION

It has now been found that it is possible to construct an implantable actuator comprising a reciprocating magnetically actuated driver being operable by means of en externally applied magnetic field. The reciprocating driver is constructed from a movable rod disposed in the actuator such that it may move back and forth thereinside in response to magnetic forces applied thereto via magnetic field coupling means.

Preferably, the magnetic coupling means is implemented by magnetic/ferromagnetic elements affixed to said movable rod and to the inner wall of the actuator housing, such that attraction (or repulsive) forces evolving between said magnetic/ferromagnetic elements in the presence of an externally applied magnetic field induce axial movements of said movable rod. Most preferably the magnetic coupling means is implemented by one or more pairs (e.g., 1 to 10) of magnetic/ferromagnetic elements disposed in the actuator such that the first magnetic/ferromagnetic elements of said pairs are affixed along said movable rod in proximity with the second magnetic/ferromagnetic elements of said pairs which are affixed along the inner wall of the housing of said actuator.

Said magnetic/ferromagnetic elements may be constructed in any suitable shape, such as cylindrical, spherical, conic, cubic, rectangular etc. In a preferred embodiment of the invention the magnetic/ferromagnetic elements have a shape of a ring, torus, or cylindrical, wherein the first magnetic/ferromagnetic elements affixed along the length of the movable rod are adapted to fit over the surface of said movable rod and the second magnetic/ferromagnetic elements are affixed along the inner wall of the housing of said actuator coaxially with the axis of said movable rod such that said movable rod if free to move back and forth therethrough.

The motion produced by the reciprocating driver is preferably delivered to transmission means provided in the actuator for transforming the reciprocating motion of the movable rod into rotary motion which may be conveniently outputted directly via a rotating shaft throughout a rotary ratchet and/or unidirectional clutch mechanisms, or amplified by means of a gear train. In another implementation of the actuator of the invention the rotary motion produced by the transmission means is translated into axial motion by means of suitable motion translation means, for example, by transferring the rotary motion to a threaded rod having a slidable member threaded thereover and engaged with the inner wall of the actuator housing by means of linear guiding means (e.g., lead screw and nut mechanism).

In the presence of an external magnetic field the one or more pairs of magnetic/ferromagnetic elements are magnetized and therefore are attracted to each other. The collision impact, between the magnetic/ferromagnetic elements, and the momentum conversation low, is used to push forward the actuator chassis in a significant axial force e.g., in the range of 1-60 Kg.

The frequency of the applied magnetic field frequency can be used to determine a frequency of vibrations of the actuator device. In this case no additional mechanism is used besides the magnetic/ferromagnetic elements embedded into the apparatus chassis. Applying vibrations by means of the invention actuator may be implemented by other techniques such as a piezo ceramic motor or rotary motor which are energized by external power sources such as wireless transmission.

In another possible implementation the same reciprocating mechanism is used without the clutch and the ratchet mechanism. In this case, the moving linear arm reciprocates back and forth in conjunction with the magnetic/ferromagnetic elements.

The implantable actuator of the invention may be used in various in-vivo applications, for example, but not limited to, as an intramedullary nail in bone lengthening or fracture treatments by creating compression or vibration in between the two fracture's segments, as described in international patent application No. PCT/IL02/00401 (published as WO 02/094113), in vertebral column distraction and oscillation applications, as described in international patent application No. PCT/IL2006/000240, in soft tissue elongation and stretching applications, or other applications requiring mechanical manipulation of body bones and organs.

### BRIEF DESCRIPTION OF THE DRAWINGS

The present invention is illustrated by way of example in the accompanying drawings, in which similar references consistently indicate similar elements and in which:

FIG. 1A is a block diagram generally demonstrating an axial actuator of the invention;

FIG. 1B schematically illustrates a preferred embodiment of an implantable magnetically activated axial actuator of the invention;

FIG. 1C schematically illustrates another implementation of the axial actuator of the invention wherein the driving force is delivered to the actuator by an arm-lever transferring means;

FIG. 1D is a block diagram generally demonstrating a rotary output actuator of the invention;

FIG. 1E schematically illustrates a preferred embodiment of an implantable magnetically activated rotary output actuator of the invention;

FIG. 1F schematically illustrates a preferred embodiment of an axial magnetically activated actuator of the invention in which the axis of rotations is perpendicular to the actuator;

FIG. 1G schematically illustrates a preferred embodiment of a rotary output magnetically activated actuator of the invention based on a linear ratchet mechanism;

FIG. 2A schematically illustrates a magnetic activation scheme wherein the windings of an electromagnet enclose an axial/rotary magnetic actuator; and

FIG. 2B schematically illustrates a magnetic activation scheme wherein the windings of an electromagnet are positioned in the proximity of an axial/rotary magnetic actuator.

### DETAILED DESCRIPTION OF PREFERRED EMBODIMENTS

The present invention is directed to an implantable magnetically activated actuator (hereinafter actuator) operated by means of a reciprocating driver. The actuator of the present invention comprise transmission means for transferring the reciprocating movement produced by the reciprocating driver into rotary movement which may be outputted directly via a rotating pivot, or transferred to said rotating pivot via gear transmission means. In other implementations of the invention the rotary motion is translated into axial motion by means of a rotary to axial motion converting means.

The reciprocating driver of the present invention is comprised of a movable rod and magnetic coupling means which are both disposed in the actuator. The magnetic coupling means preferably comprise magnetic/ferromagnetic elements affixed to the movable rod and to the inner wall of the actuator and adapted to induce axial movements of the movable rod in response to externally applied magnetic field. Most preferably the magnetic coupling means is implemented by one or more magnetic/ferromagnetic pairs, affixed to the movable rod and to the inner wall of the actuator housing, such that attraction (or repulsive) forces evolving between said magnetic/ferromagnetic elements in the presence of an external magnetic field induce axial motion of said movable rod.

The one or more pairs of magnetic/ferromagnetic elements are disposed in the actuator such that the first magnetic/ferromagnetic elements of said pairs are affixed along said movable rod in proximity to the second magnetic/ferromagnetic elements of said pairs which are affixed along the inner wall of the housing of said actuator. Reciprocating movements of the movable rod are obtained by applying an alternating magnetic field, or by repeatedly applying a magnetic field to move the movable rod forward and using a returning spring to move it backward in the time intervals in which a magnetic field is not applied.

In a preferred embodiment of the invention the magnetic/ferromagnetic elements have a shape of a ring, torus, or cylindrical, wherein the first magnetic/ferromagnetic elements affixed along the length of the movable rod are adapted to fit over the surface of said movable rod and the second magnetic/ferromagnetic elements are affixed along the inner wall of the housing of said actuator coaxially with the axis of said movable rod such that said movable rod if free to move back and forth therethrough. The dimensions of the ferromagnetic/magnetic elements are preferably in the range of 1-20 mm in diameter, and 1-100 mm in length, while their inner diameter is configured according to the diameter of the movable rod (e.g., 7-8 mm).

A ratchet mechanism is preferably used to transfer the rotary motion produced by the transmission means. In a particularly preferred embodiment of the invention the reciprocating movements of the movable rod are transferred to a transmission means comprising a motion converter implemented as a hollow member that drives a first ratchet section. The inner surface of the hollow member comprises helical slots that are engaged with rollers that are attached to the outer surface of a reciprocating plunger engaged in the hollow interior of said hollow member. The hollow member comprise a circumferential slot engaged with bearings (or rollers) attached to the inner wall of the housing of the actuator such that the axial motions transferred to said reciprocating plunger is translated into a rotary motion of said hollow member.

In one preferred embodiment the movable rod is moved forward due to an externally applied axial magnetic field. Release (or reversal) of the applied magnetic field causes backward movement of the movable rod, which is preferably affected by means of a returning spring connected between the plunger and the inner wall of the actuator.

In applications of actuators used for outputting axial movements the rotary motion transferred by the second ratchet section is translated into axial motion via a threaded rod attached thereto. A moving arm threaded over the threaded rod is moved axially thereover by means of sliding slots (or any other linear guidance) provided along the moving arms, where the sliding slots are engaged with linear guidance means attached to the inner wall of the actuator housing, thereby preventing rotary movements of the moving arm.

The driving ratchet performs a reciprocal rotation in conjunction with a moving plunger that is engaged in a hollow member comprising helical guiding means. The engagement with the driven ratchet is via saw shape teeth which provide unidirectional rotation only, wherein the coupling between the two ratchet's wheels is provided by low magnitude compression spring.

In one preferred embodiment, 1-8 pairs of ferromagnetic/magnetic elements are used, wherein said ferromagnetic/magnetic elements preferably have a cylindrical shape having an outer diameter of about 10-5 mm and length in the range of 2-5 mm. The activating magnetic field is preferably induced by one or more coils and the strength of the magnetic field applied is generally in the range of 0.01 to 3 Tesla, preferably about 0.075 Tesla.

Responsive to the applied magnetic field the magnetic/ferromagnetic elements are magnetized and in effect an axial attraction force between the elements is obtained. The attraction force between the magnetic/ferromagnetic pairs cause forward movement of the magnetic/ferromagnetic elements attached to the movable rod toward the magnetic/ferromagnetic elements attached to the inner wall of the actuator, thus moving forward the movable rod and the plunger attached thereto.

The reciprocating plunger receives the axial movements of the moving rod which rotates the hollow member about it axis as it helical slots slide over the rollers attached to the outer surface of the reciprocating plunger. The first ratchet section is attached to the hollow member and its ratchet teeth transfers the rotary movements to a rotating pivot attached to the second ratchet section which is engaged by ratchet teeth with the first ratchet section.

The actuator preferably comprise a mechanical gear for mechanically amplifying the applied force (e.g., 1.6 kg of pushing force is transformed into 100 Kg of distraction force).

When the externally induced magnetic field (e.g., by a magnetic coil in any shape e.g. circular, rectangular, square etc.) is removed, the magnetic coupling force between the magnetic/ferromagnetic elements is canceled and the movable rod is retracted backward (e.g., by means of a returning spring) to its initial state thereby restoring the initial gap between the magnetic/ferromagnetic elements. Along with the backward movement of the movable rod the reciprocating plunger mechanically link to it also moves backwards as it slides about its axis and in effect cause counter rotation of the hollow member a bout the reverse helix path of its helical slits. The counter rotation of the hollow member cause disengagement of the ratchet teeth of the first and second ratchet sections, such that this counter rotation is not transferred to the rotating pivot attached to the second ratchet section.

In a preferred embodiment of the invention, the cross-sectional shape of the ferromagnetic/magnetic pairs and the ratchet sections is made circular, but of course it is not limited to a circular shape and other geometrical shapes, such as, elliptic, conic, rectangular, square, or other shapes, can be implemented. The different members of the actuator may be solid, hollow or a combination of the two, and are manufactured by the use of the standard machining processes that are well known in the art. The different members of the actuators may be constructed from any suitable biocompatible material including (but not limited to) titanium and a biocompatible stainless steel alloy such as LVM-316.

As described hereinabove, the axial movement in one direction is caused by the magnetic forces induced by the external magnetic field acting on the reciprocating driver comprising the ferromagnetic/magnetic elements. In cases where it is required that the moving arm be capable of moving in a reverse direction, the axial movement in the other direction is caused by changing the direction of the threading of the rotating road and of the moving arm threaded thereover into the other direction (right to left instead of left to right or vice-versa).

The members of the actuator, except the magnetic/ferromagnetic elements, are constructed of a non-magnetic material. By way of example, the magnetic/ferromagnetic elements may be provided in the form of one pairs of cylindrical (or other shape, such as square), each having, for example, a diameter of 1-20 mm and a length of up to 1-100 mm (or any other suitable length according to the device dimensions). The gap between the moving and the stationary magnetic/ferromagnetic elements in each pair is preferably from 0.1 mm up to 1.3 mm or more.

In our configuration, this arrangement would consist of a series of only 1 pair of magnetic/ferromagnetic elements. It should be emphasized that this configuration is given by way of example only, and is not intended to be limiting the invention in any way. Typically, this arrangement would consist of a series of 1 to many pairs of magnetic/ferromagnetic elements.

The above-described axial movements of the actuator members may be used to cause through mechanical amplification the moving arm and the housing of the actuator to distract from each other in one embodiment (thereby increasing the total end-to-end length of the device), or cause compression in a second embodiment (thereby reducing the total end-to-end length of the device), or to oscillate in a third embodiment.

The oscillations may be produced utilizing one of the following methods:

1. Implementing the actuator of the invention using the internal reciprocating mechanism described above but without the ratchet mechanism and unidirectional clutch, such that the moving telescopic arm of the actuator directly and linearly reciprocates in accordance with the movements of the movable rod. No other internal mechanism is used where the collision impact between the stationary and the moving Ferro-magnetic cylinders is pushing the nail chassis forward against the tissue or callus or bone built up material
2. Implementing the actuator of the invention using the internal reciprocating mechanism described above with a ratchet mechanism and bi-directional clutch, such that the moving telescopic arm of the actuator reciprocates in accordance with the movements of the movable rod.

Progressive distraction can be achieved by uni-directional magnetically-induced distraction (as described hereinabove) combined with a ratchet or/and unidirectional clutch mechanism or a transmission mechanism pushing an internal and/or external screw or a slider in order to prevent backward motion.

It should be noted that the embodiments exemplified in the Figs. are not intended to be in scale and are in diagram form to facilitate ease of understanding and description. In fact, scale may vary from one portion to another of each Fig.

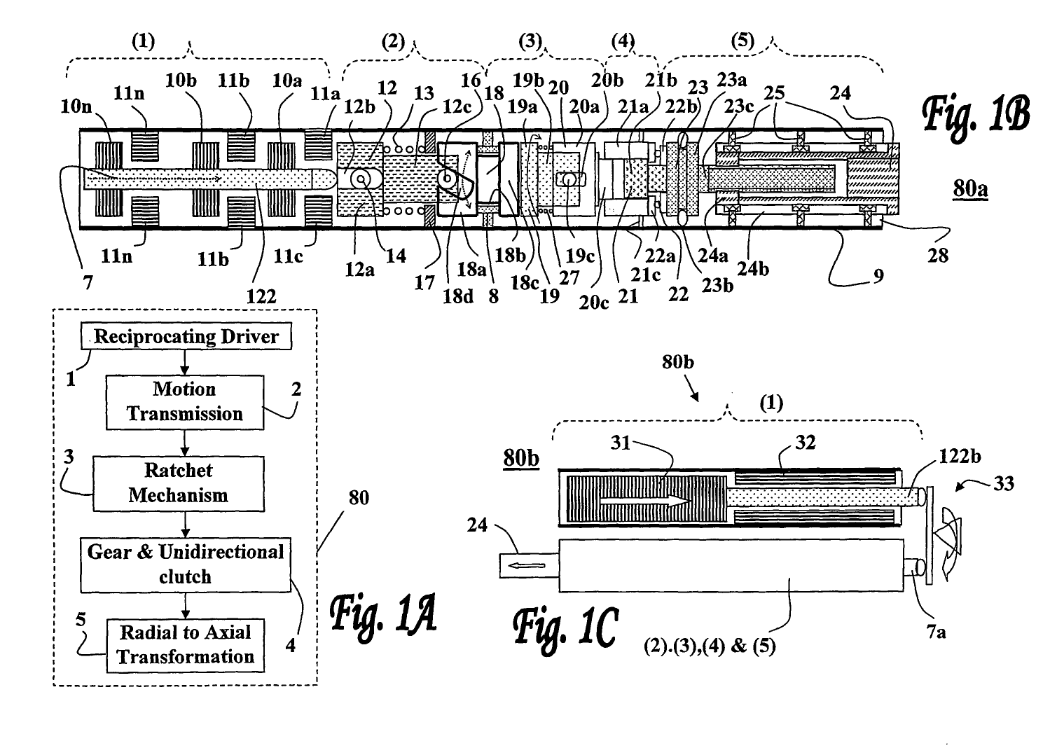

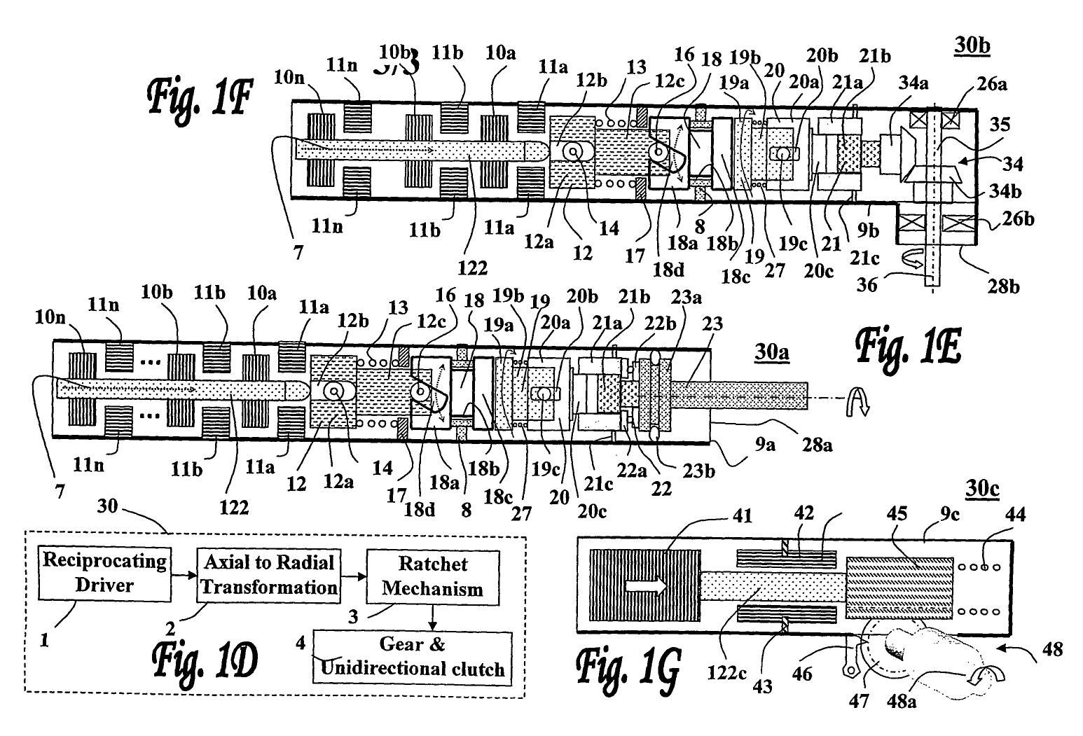

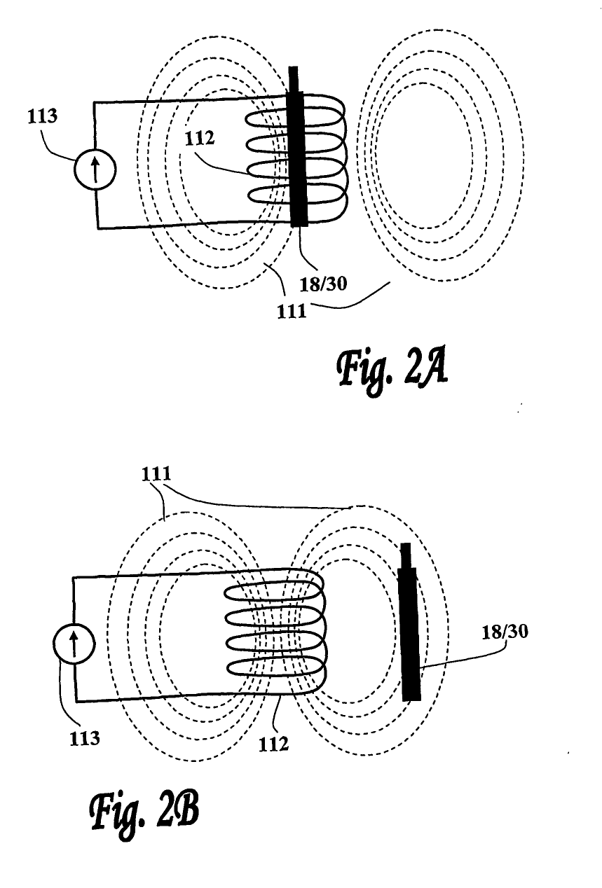

FIG. 1A is a block diagram generally demonstrating an axial movement actuator 80 of the invention. In this example the actuator 80 comprises a reciprocating driver 1 that is preferably adapted for generating reciprocating movements to a transmission unit 2 capable of transforming said reciprocating movements into angular movements, i.e., rotary motion. Said angular movements are received by a gear and unidirectional clutch unit 4 via a ratchet mechanism 3, wherein said gear is configured to allow actuation of the device with reduced moments. The rotary movements outputted by gear device 4 are then transformed into axial movements by the transformation unit 5.

FIG. 1B schematically illustrates an implementation of an implantable magnetically activated axial actuator 80a, constructed according to the scheme described above with reference to FIG. 1A. In this preferred embodiment of the invention the reciprocating driver (1) comprises stationary and movable magnetic/ferromagnetic elements, 11a-11n and 10a-10n respectively, a movable rod 7 linked to a hollow member 18 via reciprocating plunger 12, returning spring 13, and hollow coupling element 20. Rotating pivot 23 may be connected directly to the hollow coupling element 20, or via a gear 21. Upon removal of the magnetic field the ferromagnetic elements are demagnetized and returning spring 13 pushes backward the reciprocating plunger and the movable rod backwards to their initial position. A ratchet mechanism, comprising a first ratchet section 18c and a second ratchet section 19a, is provided between the connected surfaces of hollow plunger 18 and ratchet 19. Teeth engagement spring 27 is provided in order to allow ratchet 19 to slide back and forth into the interior hollow coupling element 20, thereby enabling disengagement of the ratchet sections whenever the counter rotations of hollow member 18 occur, and of course, to enable restoring teeth reengaged of the ratchet sections during the next cycle reciprocating motion.

The mechanical amplification of the magnetic force induced by the magnetic field and transformed into mechanical movements by the magnetic/ferromagnetic elements is obtained via the ratchet driven sections, and the threads of the threaded rod. The parameters threaded rod determines the amplified distraction force and its distraction step for each magnetic field pulse. In one specific preferred embodiment of the invention the rotating pivot is implemented by means of a screw having M3/0.5 mm size.

Axial actuator 80a comprises an elongated hollow body 9 used for housing the units and devices (1, 2, 3, 4 and 5) utilized in axial actuator 80a. In a preferred embodiment of the invention the reciprocating driver (1) is implemented by one or more pairs of stationary magnetic/ferromagnetic elements 11 and movable magnetic elements 10, wherein magnetic elements 11a, 11b, . . . , 11n, are affixed to the inner wall of body 9, and movable magnetic elements 10a, 10b, . . . , 10n, are affixed to movable rod 122 slidably centered thereinside.

Stationary magnetic/ferromagnetic elements 11 are configured to provide a concentric passage suitable to slidably comprise movable rod 122. Each stationary magnetic element 11 preferably occupies a circumferential cross-sectional area of hollow body 9 while providing a passage thereinside, where the passage of the adjacent stationary magnetic elements 11 are centered about the longitudinal axis of elongated body 9.

Stationary magnetic elements 11 are preferably distributed over a longitudinal section of body 9 in equal distances therebetween, and movable magnetic elements 10 are preferably distributed along movable rod 122 in corresponding distances therebetween, such that corresponding pairs of stationary and movable magnetic elements ({10a, 11a}, {10b, 11b}, . . . ) are obtained. In this way movable rod 122 may be moved horizontally, as exemplified by arrow 7, by applying a magnetic field along the longitudinal axis of elongated body 9, which in turn cause attraction forces to develop between each pair of stationary and movable magnetic elements 11 and 10.

Elongated body 9 is preferably a hollow cylindrical body manufactured from a non-magnetic material such as S.S316LVM or Titanium alloy. Its length is generally in range of 30 mm to 400 mm, preferably about 100 mm. The outer diameter of body 9 is generally in the range of 6 mm to 12 mm, preferably about 10 mm, and its inner diameter in the range of 4 mm to 8 mm, preferably about 7 mm. Stationary magnetic elements 11 are preferably cylindrical shape elements manufactured from ferromagnetic or magnetic material, such as carbon steel or industrial Ferromagnetic alloy, preferably from VACCOFLUX 50, SAE1010, SAE1018, or SAE1020, Carbon steel. The diameter of stationary magnetic/ferromagnetic elements 11 is determined to allow fitting thereof in the hollow interior of elongated body 9. Stationary magnetic/ferromagnetic elements 11 preferably comprise a hollow bore, aligned with the longitudinal axis of elongated body 9, wherein said bore is configured to allow movable rod 122 to move therethrough, for example, said bore may be in the range of 1 mm to 3.5 mm, preferably about 2 mm.

Movable rod 122 may be manufactured from Stainless steel or Titanium alloy, preferably from S.S316LVM. The length of movable rod 122 is generally in range of 20 mm to 80 mm, preferably about 30 mm, and its diameter is generally in range of 1 mm to 3 mm, preferably about 1.5 mm. The distance between pairs of magnetic/ferromagnetic elements (e.g., the distance between magnetic element 10a and 10b) along the longitudinal axis of elongated hollow body 9 is generally in range of 6 mm to 20 mm, preferably about 11 mm. The gap between the stationary magnetic/ferromagnetic elements 11 and the movable magnetic/ferromagnetic elements 10 is generally in range of 0.4 mm to 2 mm, preferably about 1.2 mm, and the magnetic force applied during operation of the actuator may bring said elements to come into contact.

As exemplified in FIG. 1B, one end tip of movable rod 122 contacts the base 12a of reciprocating plunger 12. Reciprocating plunger 12 is slidably centered in elongated body 9 by means of collar 17 and bearing (or roller) 14 which are affixed to the inner wall of elongated body 9. Collar 17 is engaged with the body section 12c of reciprocating plunger 12, wherein said body section 12c comprises a returning spring 13 disposed thereover and between said collar 17 and said base 12a. Bearing 14 engaged in a horizontal groove 12b provided on the outer surface of base 12a, prevents rotational movements thereof and utilized provide linear guidance thereto. This assembly of reciprocating plunger 12 and returning spring 13 is efficiently used in the motion transformer (2) to transfer the axial movements of movable rod 122, and to return movable rod 12 backwards to its initial position when the applied magnetic force is reduced or zeroed, thereby restoring the gap between the stationary and movable magnetic/ferromagnetic elements 10 and 11.

One end of body section 12c is attached to base 12a of reciprocating plunger 12 while its other end is slidably engaged in the hollow interior of base section 18a of hollow member 18. One or more rollers 16 provided on body section 12c are engaged in corresponding helical grooves 18d provided on the inside wall of the hollow interior of base section 18a. Alternatively, grooves 18d may be implemented as helical slits passing from the outer surface of base section 18a into its hollow interior.

Hollow interior of base section 18a of hollow member 18 should be respectively configured to allow body section 12c of reciprocating plunger 12 perform the entire axial movements forwarded thereto by movable rod 122. An annular groove 18b is provided over the outer surface of hollow member 18 for rotatably centering it in the internal space of elongated hollow body 9 by means of bearings (or rollers) 8 affixed to the inner side wall of elongated hollow body 9. This linkage between reciprocating plunger 12 and hollow member 18 by means of said rollers 16 and helical groove 18d translates the axial motion of reciprocating plunger 12 into an angular motion of hollow member 18.

Alternatively, bearing 8 may be implemented without a corresponding groove 18b, but with one or more concentric ball bearings arranged in tandem, wherein the axes of said bearings coincides with the axis of hollow member 18.

Reciprocating plunger 12 may be manufactured by lathing or mold casting in a cylindrical shape from a stainless steel or Titanium alloy, preferably from S.S316LVM. The diameter of the base 12a of reciprocating plunger 12 is generally in the range of 4 mm to 8 mm, preferably about 7.5 mm, and the diameter of its body section 12c is generally in the range of 2.5 mm to 6.5 mm, preferably about 6 mm. These dimensions can be larger or smaller depending on the outer and inner diameters of the rods.

Hollow member 18 is coupled to gear and unidirectional clutch unit (4) via ratchet mechanism (3) implemented by the coupling of a driving ratchet element 18c (first ratchet section), attached to (or formed on) a cross-sectional surface of hollow member 18, and a driven ratchet element 19a (second ratchet section) attached to (or formed on) the base of ratchet 19. For example, said ratchet sections, 18c and 19a, may be implemented by a radial saw profile tooth arrangement (not shown) provided on opposing faces of said elements, and configured such that rotations of converter 18 resulting from movements forwarded by movable rod 122 establish coupling therebetween, while the rotations in the opposite direction (counter rotations), caused by the return of reciprocating plunger 12 due to teeth engagement spring 27, breaks said coupling due to the sliding of the saw tooth ramps. Said sliding of the saw tooth ramps results in axial motions of ratchet 19, the body section 19b of which is received in a coupling element 20.

Motion converter 18 may be manufactured by lathing, milling, EDM (Electro Erosion), or mold casting, in a cylindrical shape, from stainless steel or Titanium alloy, preferably from S.S316LVM. The length of hollow member 18 is generally in the range of 6 mm to 8 mm, preferably about 7 mm, its diameter is generally in the range of 6 mm to 8 mm, preferably about 7.5 mm, and the angular motions it performs are generally in the range of 4° to 12°, preferably about 6.4°.

As illustrated in FIG. 1B, the cross section of body section 19b of ratchet 19 is smaller than the cross section area of the driven ratchet element 19a, which defines an annular recess between driven ratchet element 19a and coupling element 20, wherein teeth engagement spring 27 resides. The hollow base 20a of coupling element 20 is configured to receive an end portion of body section 19b of ratchet 19 thereinto and any axial movements thereof during the sliding of the saw tooth ramps. Returning teeth engagement spring 27 retract portion of said body section 19b from the interior of hollow base of coupling element 20, thereby restoring the coupling between ratchet elements, 18c and 19a.

Backwards angular motion of ratchet 19 is prevented by means of friction like O-ring seal, the shape of the interacted teeth's profile angle (moderate), and the unidirectional clutch. A sliding pin 19c, provided on body section 19b of ratchet 19, transfers the angular displacements of driven ratchet element 19a to coupling element 20. The hollow interior of coupling element 20 receives body section 19b of ratchet 19 and sliding pin 19c provided thereon is received in horizontal groove 20b, thus allowing ratchet 19 to move back and forth, linearly guided, while the ratchet teeth of ratchet elements, 18c and 19a, are being engaged/disengaged during their rotation.

Ratchet 19 may be manufactured by lathing, milling, EDM (Electro Erosion), or mold casting, in a cylindrical shape from stainless steel or Titanium alloy, preferably from S.S316LVM. The diameter of driven ratchet element 19a of ratchet 19 is generally in the range of 6 mm to 8 mm, preferably about 7.5 mm, and its length is preferably about 2 mm. The diameter of body section 19b of ratchet 19 is generally in the range of 4.5 mm to 6.5 mm, preferably about 5.5 mm, and its length if preferably about 5 mm.

Coupling element 20 may be manufactured by lathing or mold casting in a cylindrical shape from stainless steel or Titanium alloy, preferably from S.S316LVM. The outer diameter of hollow base 20a is generally in the range of 6 mm to 8 mm, preferably about 7.5 mm, and its length is preferably about 6 mm. The inner diameter of hollow base 20a is generally in the range of 5 mm to 7 mm, preferably about 6 mm, and its length is preferably about 6 mm. The diameter of coupling portion 20c of coupling element 20 is generally in the range of 2 mm to 8 mm, preferably about 5 to 7.5 mm, and its length is preferably about 7 mm.

The rotations transferred by coupling element 20 are received via coupling portion 20c thereof in gear 21. The chassis 21a of gear and unidirectional clutch 21 is affixed to inner wall of elongated hollow body 9, and a stationary part 22a of thrust bearing element 22 is affixed on its cross section surface. The rotating part 22b of said thrust bearing element is affixed to the base 23a of rotating shaft 23. Thrust bearing element is designed to absorb external shocks and payload axial force which may be delivered via rotating shaft 23. A cross sectional portion area of said base 23a is coupled to the output shaft 21b of gear 21, where said output shaft 21b outputs rotational movements received via coupling portion 20c and which are transformed by transmission elements (not shown) of gear 21. An annular groove may be formed on the circumference of said base 23a in which O-ring 23b may be mounted for sealing elongated hollow body 9. O-ring 23a may be implemented by a single, or a pair of, silicone O-rings mounted in grooves provided in base 23a of rotating shaft 23.

Gear and unidirectional clutch 21 may be a type of planetary gear head (e.g., 16/1 of Faulhaber group), its diameter is generally in the range of 6 mm to 8 mm, preferably about 7.5 mm, and its length is preferably about 6 mm. The unidirectional clutch is preferably an “of the shelve” unidirectional clutch, such as manufactured by INA integrated in a gear and unidirectional clutch 21. Thrust bearing element may be implemented by F3-8M manufactured by SAPPORO PRECISION INC.

Rotating pivot 23 comprises a threaded section 23c for translating the rotational motions received via gear 21 into linear movements outputted via moving arm 24 slidably centered inside elongated hollow body 9. Some portion of moving arm 24 is made hollow and its internal space can be accessed via an opening provided by the bore of nut 24a mounted at the base of moving arm 24. Moving arm 24 may further comprise horizontal grooves 24b for receiving linear guiding means 25 such as rollers, keys, pins, and the like, affixed to respective locations on the inner wall of elongated hollow body 9.

Rotating pivot 23 may be manufactured from stainless steel or Ti alloy, preferably from S.S316LVM, its diameter is generally in the range of 5 mm to 7.5 mm, preferably about 7 mm, and its length is preferably about 50 mm. Moving arm 24 may be manufactured by lathing and milling from stainless steel or Titanium alloy, preferably from S.S316LVM, its diameter is generally in the range of 8 mm to 7 mm, preferably about 7.5 mm, and its length is preferably about 90 mm. The diameter of the hollow interior of moving arm 24 is generally in the range of 2.4 mm to 4.4 mm, preferably about 3.4 mm, and its length is preferably about 50 mm.

The axial motion output of magnetic actuator 18a is provided by axial movements of moving arm 24 which protrudes outwardly via opening 28 of elongated hollow body 9. Said axial motion is obtained from the angular motion outputted by gear 21 which is translated by the threaded section 23c of rotating pivot 23 and the nut 24a affixed to the opening to the hollow interior of moving arm 24 into corresponding axial movements.

The magnetic actuation scheme described hereinabove may be used to implement a reciprocating motion device (e.g., for oscillation purposes) operating with lower force magnitudes (e.g., up to 10 Kg pushing/pulling force). Such reciprocating motion device may be implemented using pairs of magnetic/ferromagnetic elements ({10a, 11a}, {10b, 11b} . . . {10n, 11n}) and a movable rod (122) and returning spring (13), as described above. The motion converters, ratchet mechanism and gear and clutch devices are not needed in such implementation. Furthermore, the magnetic actuation may be implemented in using various magnetic/ferromagnetic elements arrangements using 3 such elements in tandem, for instance 2 moving ferromagnetic/magnetic elements and one stationary.

The actuator may also comprise a monitoring feedback device for measuring directly or indirectly the axial/rotary movements of the actuator and output corresponding indications. For example, the monitoring feedback device may be implemented by one of the following options:

1. RF Transmission—A standard miniature RF transmitter may be located inside the actuator. Said RF transmitter may be energized via a small battery and transmit system displacement (rotary or linear) to an external monitor. A RF antenna can be located external to the actuator.

The rotary or linear displacement measuring may be carried out using a rotary chopper disc (disc with many slots) passing through an opto-coupler device (Infra red solid state diode illuminating a receiver) capable of counting the received pulses. Similarly, a capacitance proximity sensor, a Hall Effect proximity switch, a mechanical switch, or a rotary or linear encoder, may be used in such implementation to provide readout of the measured movements.

2. An internal Buzzer alert may be used to provide indication relating to the measured movements. The buzzer may be located inside the actuator, such that whenever it is indicated that the required elongation was accomplished the buzzer is energized and generates an audible signal that may be sensed by an external microphone located outside the body of the treated subject.

3. A mechanical internal feedback scheme may utilize to lock the Ferro-magnets/magnets actuation system whenever a complete elongation cycle (e.g., 0.25 mm) is accomplished. In this way, an external microphone may be used to sense that no internal impact noise is created and stop the elongation. An additional electro-magnetic field or internal mechanism may be used to actuate the locking index into a disable position in which it is ready for the next elongation treatment.

FIG. 1C schematically illustrates another possible embodiment of a magnetically-actuated linear actuator 18b of the invention wherein the driving force is delivered from a reciprocating driver (1) by an arm-lever transferring means 33. In this example the reciprocating driver (1) is implemented by a unit comprising a single pair (or several pairs) of ferromagnetic/magnetic element(s), movable ferromagnetic/magnetic element(s) 31 attached to movable rod 122b which passes through stationary ferromagnetic/magnetic element(s) 32 affixed to the inner wall of the driving unit. The axial movements produced by this driving unit in the presence of an alternating magnetic field are transferred by an arm-lever transferring means 33 to a parallel unit comprising axial to rotary motion transformation means (2), ratchet mechanism (3), gear and unidirectional clutch unit (4), and rotary to axial motion transformation means (5), similar to those which were previously described hereinabove. As demonstrated in FIG. 1C, such implementation can effectively provide a magnetic actuator having a shorter longitudinal length. The arm-lever means 33 may be encapsulated inside the actuator hollow body, for example where the plunger (12 in FIG. 1B) and return spring (13 in FIG. 1B) to prevent backlash. The rotary arm of arm-lever means 33 may be implemented by a pivoted rod rotatably supported at the center of its length to assure pure rotational displacement.

FIG. 10 is a block diagram demonstrating construction of an actuator 30 of the invention which outputs rotary movements. Actuator 30 is substantially similar to actuator 18, which was described hereinabove with reference to FIG. 1A. Actuator 30 comprises reciprocating driver 1, axial to rotary motion transformer 2, a ratchet mechanism 3, and a gear and unidirectional clutch device 4. As demonstrated in FIG. 1E, a rotary motion magnetic actuator 30a may be constructed with similar components as in the axial magnetic actuator which was described hereinabove with reference to FIG. 1B. In this implementation rotary magnetic actuator 30a outputs rotary motion directly via rotating pivot 23, the end tip of which may protrude outwardly via opening 28a of elongated hollow body 9a.

FIG. 1F schematically illustrates a magnetic rotary actuator 30b of the invention in which the axis 36 of the outputted rotary motions is perpendicular to the axis of the elongated hollow body of the actuator 30b. Actuator 30b may comprise a reciprocating driver (1), axial to rotary motion transformer (2), ratchet mechanism (3), and gear and unidirectional device (4), similar to those described herein above with reference to FIG. 1B. In this implementation the rotary motions outputted by gear device 21 are transferred to rotating shaft 35 via bevel gear 34 comprised of conical transmission wheels 34a and 34b. In this case elongated hollow body 9b is preferably formed in a “L” shape having an opening 28b perpendicular to the axis of elongated hollow housing 30b. The base of transmission wheel 34a is coupled to output shaft 21b of gear 21, and its tapered end is coupled to the tapering end of transmission wheel 34b. Rotating shaft is concentrically affixed in transmission wheel 34b and is rotatably affixed to the inner wall of elongated hollow body 9b via supports 26a and 26b.

Bevel gear 34 may be a type of straight, spiral or hypoid shape gear, manufactured by milling from stainless steel or Titanium alloy, preferably from S.S316LVM. Of course, the rotary motion may be transferred perpendicularly using other gear means, such as a worm gear.

FIG. 1G schematically illustrates a rotary magnetic actuator 30c of the invention based on a standard linear ratchet mechanism. In this example, elongated hollow body 9c comprises a pair of magnetic/ferromagnetic elements, movable magnetic/ferromagnetic element 41 attached to movable rod 122c which passes through stationary magnetic/ferromagnetic element 42 affixed to the inner wall of elongated hollow body 9c via supports 43. The axial movements produced by this driving unit in the presence of an alternating magnetic field are transferred via movable rod 122c to a linear ratchet 45 coupled to driven rotary ratchet 47. Return spring 44, which returns movable rod 122c to its initial position, after each magnetic activation, is mounted between inner end wall of elongated hollow body 9c and linear ratchet 45. Pawl mechanism may used to prevent angular backward motion of driven rotary ratchet 47 during the return cycles of movable rod 122c. Gear head 48, outputting angular motions via output shaft affixed thereto, may be concentrically affixed to driven rotary ratchet 47.

Linear ratchet 45 is guided linearly via rolling or friction means to maintain consistent coupling with the rotary driven ratchet 47. Linear ratchet 45 may be manufactured by milling or mold casting from stainless steel or titanium alloy, preferably from S.S316LVM. Driven rotary ratchet 47 is designed to output a desired angular motion; it may be manufactured by milling, EDM, or mold casting from a stainless steel or Titanium alloy, preferably from S.S316LVM. Gear head 48 is preferably a type of planetary gear head, manufactured by milling or mold casting from a stainless steel or Ti alloy, preferably from S.S316LVM.

FIGS. 2A and 2B demonstrate magnetic activation schemes which may be possibly used in activating the actuator the invention. As exemplified in FIG. 2A the windings of electromagnet 112 may enclose the magnetic actuator 18/30 (18—axial actuator; rotary actuator) of the invention. In this way the magnetic actuator can be actuated by magnetic flux 111 emanating from electromagnet 112 and passing therethrough, when connected to an electrical current source 113. Alternatively, as exemplified in FIG. 2B electromagnet 112 may be located adjacent to actuator 18/30 such that magnetic flux 111 surrounding it can actuate it. Of course, other magnetic field sources may be similarly used, such as a permanent magnet.

The magnetic field induced by the electromagnet 112 is in the range of 0.01 Tesla to 3 Tesla. The magnetic forces induced by electromagnet 112 are generally in the range of 0.1 Kg to 20 Kg. Electromagnet 112 may be helmholtz type such as manufactured by TESLA. The electrical currents driven by current source 113 are sinusoidal alternating currents or DC currents, generally in the range of 1 to 500 Amper, preferably about 50 Amper, and their frequency is generally in the range of 0.01 to 50 Hz, preferably about 1 Hz. The current source 113 operates from 1-3 phase outlets.

Electromagnet 112 may comprise 1 or 2 serially connected coils, wherein said coils are encapsulated, or partially encapsulated, in a suitable Ferromagnetic shielding such as carbon steel to minimize environmental electro magnetic field interferences, and to concentrate the electro magnetic flux within an active area.

All of the abovementioned parameters are given by way of example only, and may be changed in accordance with the differing requirements of the various embodiments of the present invention. Thus, the abovementioned parameters should not be construed as limiting the scope of the present invention in any way. In addition, it is to be appreciated that the different rods, plungers, and other members, described hereinabove may be constructed in different shapes (e.g. having oval, square etc. form in plan view) and sizes differing from those exemplified in the preceding description.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. An implantable magnetically activated actuator suitable for causing distraction, compression/contraction and/or oscillation of body organs and/or bones, comprising:
a hollow housing comprising rear and front ends;
a rod movably disposed in the rear portion of said hollow housing;
magnetic coupling means comprising static magnetic/ferromagnetic elements affixed along the inner wall of said hollow housing and movable magnetic/ferromagnetic elements affixed along said movable rod in proximity to said stationary magnetic/ferromagnetic elements;
mechanical means for transferring reciprocating motion of said movable rod.

2. The implantable magnetically activated actuator according to claim 1, wherein the magnetic coupling means comprises one or more pairs of magnetic/ferromagnetic elements, each of which comprising a static magnetic/ferromagnetic element affixed to the inner wall of said hollow housing and a movable magnetic/ferromagnetic element affixed to said movable rod in proximity of said stationary magnetic/ferromagnetic element.

3. The implantable magnetically activated actuator according to claim 1, wherein the means for transferring the reciprocating motion comprises transmission means for transforming linear motion of said movable rod into rotational motion.

4. The implantable magnetically activated actuator according to claim 1, wherein the means for transferring the reciprocating motion comprises ratchet means and/or unidirectional clutch.

5. The implantable magnetically activated actuator according to claim 1, wherein the means for transferring the reciprocating motion comprises a gear.

6. The implantable magnetically activated actuator according to claim 3, wherein the means for transferring the reciprocating motion comprises means for transforming the rotary motion into axial motion.

7. The implantable magnetically activated actuator according to claim 3, wherein the means for transforming the rotary motion into axial motion comprises a threaded pivot threaded through a moving arm slidably disposed in the hollow housing.

8. The implantable magnetically activated actuator according to claim 1, wherein said actuator is activated by an externally applied magnetic field, wherein the applied magnetic field is uniform and/or homogenous.
